(19) United States
(12) Patent Application Publication
(10) Pub. No.: US 2008/0218720 A1
(43) Pub. Date: Sep. 11, 2008

(54) EXPOSURE APPARATUS AND METHOD OF MANUFACTURING DEVICE

(75) Inventor: Takehiko Mayama, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/033,320

(22) Filed: Feb. 19, 2008

(30) Foreign Application Priority Data
Mar. 9, 2007 (JP) 2007-060903

(51) Int. Cl. G03B 27/54

(52) U.S. Cl. 355/67

(57) ABSTRACT

An exposure apparatus for exposing a substrate to light includes a projection optical system which includes an optical element and a driving unit configured to move the optical element, and is configured to project light from an original to the substrate, a support mechanism which includes a gas spring and is configured to support the projection optical system via the gas spring, a control unit configured to generate a driving signal for the driving unit, and an actuator configured to apply a force, in accordance with the driving signal, to the projection optical system in a direction opposite to the direction of the reaction force accompanied by the action force from the driving unit to the optical.

### BACKGROUND OF THE INVENTION

1. Field of the Invention

The present invention relates to an exposure apparatus in which a projection optical system has a driving unit.

2. Description of the Related Art

Along with an increase in the accuracy of a semiconductor exposure apparatus, a demand has arisen for an anti-vibration/vibration suppression technique with a higher performance. This is to prevent an exposure stage, a structure which forms the exposure apparatus main body, a projection lens, or the like from generating vibration which adversely affects exposure. Such an anti-vibration/vibration suppression technique is required to insulate the exposure apparatus main body from external vibration generated by, e.g., an apparatus installation base as much as possible, and to quickly reduce vibration generated by the operation of a unit having a driving unit, such as a stage unit mounted on the apparatus main body.

The semiconductor exposure apparatus performs exposure while moving a silicon wafer onto which a circuit pattern is transferred by exposure or an original (also called a reticle or mask) having the circuit pattern. More specifically, the semiconductor exposure apparatus controls to drive a stage unit which mounts a wafer (and a stage unit which mounts a reticle), with an intermittent operation pattern called step & repeat or step & scan. It is therefore necessary to prevent the reaction forces of the stage units upon driving them from generating vibration of the apparatus main body. This is because when the apparatus main body generates vibration, it adversely affects the performances of the stage units themselves and an optical system and measurement system mounted on bases which mount the stage units.

To meet these demands, an active anti-vibration apparatus has been developed and is widely applied to the semiconductor exposure apparatus. The active anti-vibration apparatus detects the vibration and position of a base which mounts the apparatus main body by a sensor, and drives an actuator which applies a controlled force to the base on the basis of the detection result, thereby removing the vibration of the apparatus main body. The active anti-vibration apparatus also adopts a technique of compensating a driving signal from a unit having a driving unit, such as a stage unit mounted on a base and feed-forwarding it to the actuator, thereby effectively suppressing the vibration.

An active anti-vibration apparatus described in Japanese Patent Laid-Open No. 11-294520 (FIGS. 1 and 4) reduces/suppresses the vibration of a base by using a gas spring which supports the base as an air actuator, and using an electromagnetic linear motor arranged dynamically parallel to it. The active anti-vibration apparatus detects, e.g., any displacement and acceleration of the base by a sensor, and controls each actuator for anti-vibration operation using a signal obtained by executing arithmetic compensation operation for the detection result. In addition, the active anti-vibration apparatus controls each actuator by simultaneously using a signal obtained by compensating a signal from a stage unit mounted on the base, thereby more effectively controlling the vibration.

Especially, an active anti-vibration apparatus which mounts a stage unit having a driving unit has conventionally used a control method of feed-forwarding a signal corresponding to the driving reaction force of the stage unit to an actuator which applies a controlled force to a base which mounts the stage unit, thereby quickly reducing/damping the vibration. Techniques of this type are disclosed in Japanese Patent Laid-Open Nos. 11-294520 and 10-311364. (pp. 4 & 5, FIG. 1).

In recent years, to further improve a performance for insulating/removing vibration transmitted from an apparatus installation base, an active anti-vibration apparatus of this type tends to be designed such that an anti-vibration support mechanism has a lower supporting rigidity than before. However, when the supporting rigidity of the anti-vibration support mechanism is decreased to improve the vibration removal performance, the influence of the operation of a unit which is mounted on the anti-vibration apparatus and produces a smaller driving reaction force becomes problematic, unlike the conventional apparatuses.

For example, a semiconductor exposure apparatus which drives a projection lens in a projection optical system on the basis of a predetermined target value to correct the aberration or magnification change of the image plane is under study nowadays. An apparatus of this type drives the projection lens in an exposure operation, so attention must be paid to vibration generated by its driving reaction force.

A semiconductor exposure apparatus of a scanning exposure scheme which transfers a circuit pattern on a reticle (original) onto a silicon wafer by exposure while synchronously scanning a stage unit which mounts the wafer and a stage unit which mounts the reticle has come into widespread use nowadays. Such a scanning exposure apparatus need drive the projection lens in real time to perform an exposure operation in synchronism with the driving of the stage units. It is therefore necessary to more quickly suppress vibration generated by the driving reaction forces of the stage units and projection lens so as to satisfy a good exposure performance.

Various kinds of techniques have been developed for conventional semiconductor exposure apparatuses by attaching importance to reducing the vibration of a base which mounts a stage unit, due to its driving force that applies an especially large action force to the base.

However, when a projection lens is driven as described above, its driving reaction force acts on a base which mounts it. Especially in a scanning exposure apparatus, for example, to accurately correct the aberration of the image plane, it is necessary to control the position of the projection lens with high speed and high accuracy in accordance with the scanning speed of a stage. As an action force applied from the projection lens to the base increases, the sensitivity of the base with respect to vibration also increases. Note also that this lens driving can be executed in synchronism with a stage operation and exposure operation at higher speeds than before.

### SUMMARY OF THE INVENTION

According to an exemplary embodiment of the present invention, there is provided an exposure apparatus which reduces its vibration due to the reaction force accompanied by driving an optical element in a projection optical system.

According to one aspect of the present invention, there is provided an exposure apparatus for exposing a substrate to light, the apparatus comprising:
a projection optical system including an optical element and a driving unit configured to move the optical element, the projection optical system configured to project light from an original to the substrate;
a support mechanism including a gas spring and configured to support the projection optical system via the gas spring;
a control unit configured to generate a driving signal for the driving unit; and
an actuator configured to apply a force, in accordance with the driving signal, to the projection optical system in a direction opposite to a direction of a reaction force accompanied by an action force from the driving unit to the optical element.

Further features of the present invention will become apparent from the following description of exemplary embodiments with reference to the attached drawings.

### BRIEF DESCRIPTION OF THE DRAWINGS

FIG. 1 is a view showing the schematic arrangement of a semiconductor exposure apparatus according to the first embodiment;

FIG. 2 is a block diagram showing a configuration of a control unit according to the first embodiment;

FIG. 3 is a flowchart for explaining the operation of the control unit according to the first embodiment;

FIG. 4 is a block diagram showing a configuration of a control unit according to the second embodiment;

FIG. 5 is a view schematically showing the arrangement of a projection optical system according to the third embodiment;

FIG. 6 is a view schematically showing the arrangement of the projection optical system according to the third embodiment;

FIG. 7 is a flowchart illustrating the overall sequence of a process of manufacturing a semiconductor device; and

FIG. 8 is a flowchart illustrating the detailed sequence of the wafer process shown in FIG. 7.

### DESCRIPTION OF THE EMBODIMENTS

Preferred embodiments of the present invention will now be described in detail in accordance with the accompanying drawings.

As described above, a mechanism which drives a projection lens in a projection optical system to correct the aberration or magnification change of the image plane has been developed and is implemented in a recent semiconductor exposure apparatus. This lens driving mechanism can increase the image performance of the projection optical system by driving the projection lens itself in accordance with the exposure state, thereby obtaining an exposure performance closer to a limit. This projection lens driving is often performed in synchronism with a stage operation and exposure operation.

In anti-vibration control of an exposure apparatus according to the following embodiments, an actuator which applies controlled forces to a projection optical system and base cancels the driving reaction force of a projection lens produced upon driving it as described above. This quickly reduces the vibration of the base and projection optical system generated by the driving reaction force of the projection lens upon driving it to correct the aberration or magnification change of the image plane.

Especially in recent years, along with an improvement in the performance of a scanning exposure apparatus, an apparatus which performs exposure while driving a lens in synchronism with the scanning of a stage unit is under development. Since such an apparatus drives the lens at a higher speed along with an improvement in scanning speed, the driving reaction force of the lens upon driving it increases. Under the circumstance, according to the embodiments to be described below, the present invention can achieve a vibration environment more silent than in the prior arts even while meeting a stricter apparatus operation condition. This makes it possible to attain a more satisfactory vibration control performance and even a more satisfactory exposure performance of a semiconductor exposure apparatus.

### First Embodiment

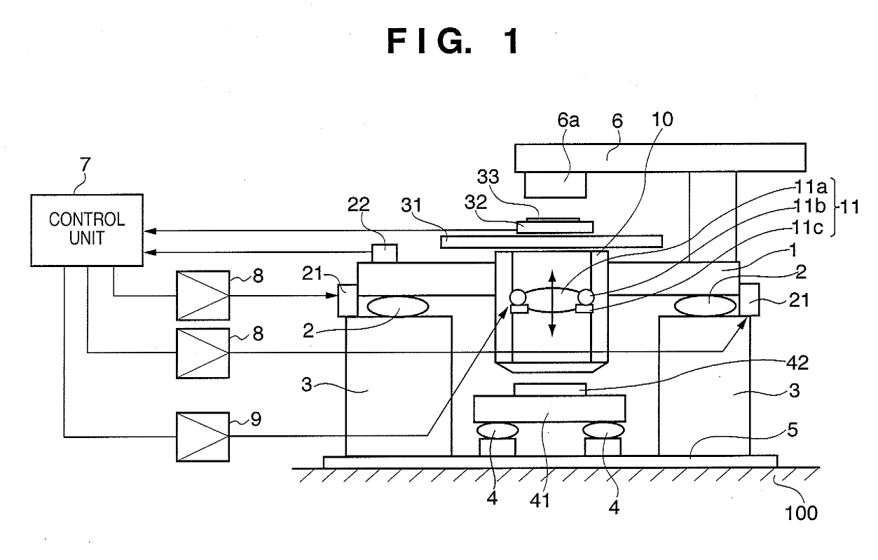

FIG. 1 is a view showing the schematic arrangement of an exposure apparatus according to the first embodiment.

As shown in FIG. 1, the exposure apparatus according to this embodiment has a base structure including a first base structure 5 and second base structure 3 installed on an apparatus installation base 100. The base structure is sometimes also called, e.g., a pallet or base frame. A stage base 41 is set on the first base structure 5 via an anti-vibration support mechanism 4. A wafer stage unit 42 which mounts a silicon wafer onto which a circuit pattern is to be transferred by exposure is set on the stage base 41.

A lens barrel base 1 is set on the second base structure 3 via an anti-vibration support mechanism 2. The lens barrel base 1 mounts a reticle stage base 31 on which a reticle stage unit 32 is set, and a projection optical system 10. The projection optical system 10 is used to project and transfer the circuit pattern of an original (to be referred to as a reticle 33 hereinafter) mounted on the reticle stage unit 32 onto a silicon wafer.

Although the anti-vibration support mechanisms 4 and 2 are set on the base structure in the semiconductor exposure apparatus according to this embodiment, they are sometimes directly installed on the apparatus installation base 100.

The base structures 3 and 5 function as references for maintaining the relative positional relationships between units set on the anti-vibration support mechanisms 4 and 2 and between these units and other units (not shown) which are not set on the anti-vibration support mechanisms 4 and 2. The base structures 3 and 5 sometimes function as base members which mount the entire semiconductor exposure apparatus and are used to collectively transport it.

The projection optical system 10 as a projection optical system is inserted between the reticle stage unit 32 and the wafer stage unit 42. Exposure light which is guided from an illumination optical system 6a to the reticle 33 and transmitted through the reticle 33 is projected onto the silicon wafer on the wafer stage unit 42 via the projection optical system 10. The circuit pattern on the reticle 33 is thus projected onto the silicon wafer on the wafer stage unit 42 to form a circuit pattern on the silicon wafer.

Semiconductor exposure apparatuses are classified into, e.g., a one-shot exposure type (stepper) and scanning exposure type (scanner) in accordance with their exposure schemes. A one-shot exposure apparatus performs one-shot exposure in a given exposure area, e.g., an area corresponding to one integrated circuit such as an IC while sequentially driving the wafer stage unit 42 by an intermittent operation scheme called step & repeat. A scanning exposure apparatus transfers a circuit pattern on a reticle onto a wafer by exposure while synchronously scanning the wafer stage unit 42 and reticle stage unit 32.

A recent wafer stage unit 42 sometimes requires no anti-vibration support mechanism 4 to attain a predetermined performance along with an increase in its performance. In this case, the stage base 41 and wafer stage unit 42 are installed on the apparatus installation base 100 or first base structure 5 without any anti-vibration support mechanism 4.

Likewise, the performance of the reticle stage unit 32 is also increasing. When such a high-performance reticle stage unit 32 is adopted, the reticle stage unit 32 is sometimes mounted on a structure which is different from the projection optical system 10 and lens barrel base 1 and is not supported by the anti-vibration support mechanism 2.

The following embodiment will exemplify a semiconductor exposure apparatus which decreases the influence of the driving reaction forces of several projection lenses, which are built in the projection optical system 10, upon driving them on the lens barrel base 1 which mounts the projection optical system 10, thereby reducing/suppressing the vibration of the lens barrel base 1.

As shown in FIG. 1, the semiconductor exposure apparatus according to the first embodiment has an arrangement in which the anti-vibration support mechanism 2 which supports with vibration control the lens barrel base 1 which mounts units of the apparatus, that include the projection optical system 10 and are vulnerable to vibration. The semiconductor exposure apparatus has actuators 21 which apply controlled forces to the lens barrel base 1. Since the lens barrel base 1 supports the projection optical system 10, the actuators 21 apply controlled forces to the projection optical system 10 via the lens barrel base 1. For illustrative convenience, FIG. 1 shows two anti-vibration support mechanisms 2 and two actuators 21 of the lens barrel base 1. However, an actual apparatus desirably has three or more anti-vibration support mechanisms 2 and three or more actuators 21, including those which are not shown. More specifically, it is desirable to arrange anti-vibration support mechanisms 2 and actuators 21 at three or more positions around the lens barrel base 1, and allow control of the rigid-body motion of the lens barrel base 1 with six degrees of freedom in the vertical and horizontal directions. Depending on requirements associated with the position/attitude or orientation (hereinafter referred to as attitude)/vibration of the lens barrel base 1, it is also possible to arrange anti-vibration support mechanisms 2 and actuators 21 so that they act on the lens barrel base 1 with only three degrees of freedom in the vertical directions. The anti-vibration support mechanisms 2 and actuators 21 are mounted on the second base structure 3, and the second base structure 3 is set on the first base structure 5 installed on the apparatus installation base 100. However, the first base structure 5 and second base structure 3 can also be separately installed on the apparatus installation base 100.

As shown in FIG. 1, the projection optical system 10 is arranged above the wafer stage unit 42. The reticle stage base 31 is arranged above the projection optical system 10, and the reticle stage unit 32 which mounts the reticle 33 and controls to align it is mounted on the reticle stage base 31. An illumination system 6 having the illumination optical system 6a for emitting illumination light to form a circuit pattern by exposure is arranged above the reticle stage unit 32.

As described above, the reticle stage base 31, reticle stage unit 32, and illumination system 6 may be rigidly fastened on the lens barrel base 1, as shown in FIG. 1, or may be set on a structure supported by the apparatus installation base 100 separately from the lens barrel base 1.

The projection optical system 10 has a movable lens unit 11 serving as a lens driving mechanism which drives a projection lens. The movable lens unit 11 corrects the aberration or magnification change of the image plane in synchronism with the operations of the wafer stage unit 42 and reticle stage unit 32 or in accordance with other apparatus environmental factors. The movable lens unit 11 has a projection lens 11a, a lens driving unit 11b which changes the attitude of the projection lens 11a, and a lens sensor 11c which detects the attitude of the projection lens 11a. The movable lens unit 11 is mounted on at least one lens of a plurality of projection lenses of the projection optical system 10. Although FIG. 1 shows only one movable lens unit 11 in the projection optical system 10 for the sake of simplicity, the projection optical system 10 has a plurality of projection lenses including the movable lens unit 11 in practice. The projection optical system 10 may have a plurality of movable lens units 11.

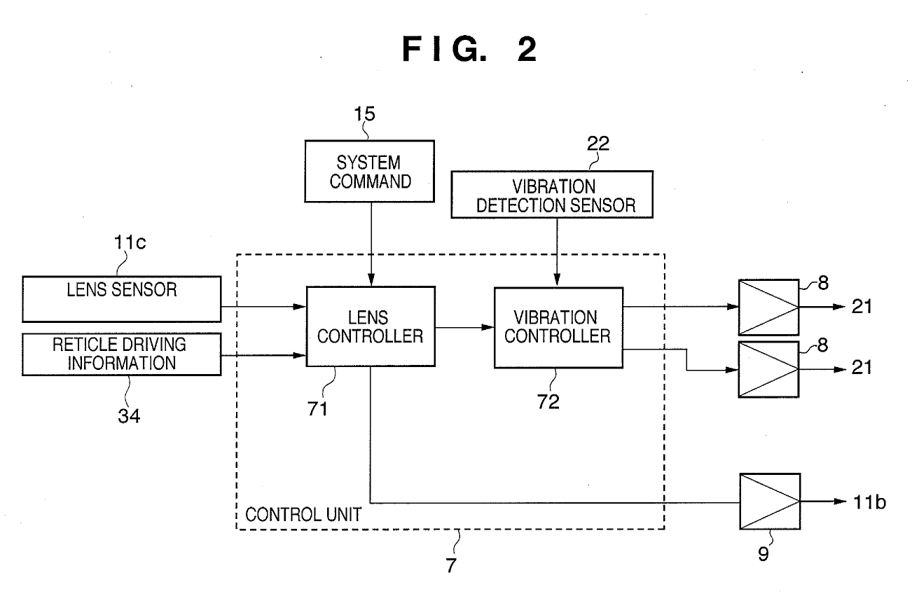

A control unit 7 controls to drive the movable lens unit 11. Details of the control unit 7 will be described later with reference to FIG. 2. The control unit 7 has a lens controller 71 and vibration controller 72. The lens controller 71 generates a lens driving signal for driving the movable lens unit 11 to correct the aberration or magnification change of the image plane, and outputs it to a lens driving circuit 9. The lens driving circuit 9 drives the movable lens unit 11 on the basis of the lens driving signal received from the lens controller 71. The lens controller 71 thus controls the movable lens unit 11.

The vibration controller 72 executes arithmetic compensation operation for the above-described lens driving signal and a signal from a vibration detection sensor 22 which detects the vibration of the lens barrel base 1, to generate an actuator driving signal for driving each actuator 21. An actuator driving circuit 8 drives a corresponding actuator 21 in accordance with the actuator driving signal received from the vibration controller 72. That is, the control unit 7 controls each actuator 21 by generating, on the basis of the above-described lens driving signal, an actuator driving signal for driving the actuator 21 so as to reduce the vibration of the projection lens 11a upon driving it by the movable lens unit 11.

The vibration detection sensor 22 detects the vibration of the lens barrel base 1. The actuator 21 can be an electromagnetic actuator such as a linear motor, which exhibits a satisfactory response performance with respect to a driving signal.

The actuator 21 which applies a controlled force to the lens barrel base 1 basically includes an actuator which applies a controlled force to the lens barrel base 1 in the vertical direction, and an actuator which applies a controlled force to it in the horizontal direction. However, it is possible to omit an actuator for a direction in which a controlled force need not substantially be applied from the viewpoint of the arrangement, if any.

The anti-vibration support mechanism 2 which supports the lens barrel base 1 with vibration control can be a pneumatic actuator including, e.g., a gas spring and an electropneumatic proportional valve which controls its internal pressure. In this case, the anti-vibration support mechanism 2 controls the pneumatic actuator on the basis of at least one of signals output from a displacement detection sensor which detects any displacement of the lens barrel base 1 with respect to a reference position and from a vibration detection sensor which detects the velocity or acceleration of the lens barrel base 1. With this operation, the pneumatic actuator reduces the vibration of the lens barrel base 1. More specifically, the control unit 7 executes arithmetic compensation operation to reduce the vibration of the lens barrel base 1 on the basis of a detection signal from the displacement detection sensor and/or vibration detection sensor, and controls the pneumatic actuator on the basis of the arithmetic compensation operation result. In other words, an active anti-vibration apparatus which correctly maintains the position/attitude of the lens barrel base 1 in a predetermined state by, e.g., the displacement detection sensor, vibration detection sensor, control unit 7, and pneumatic actuator, and actively controls the vibration of the lens barrel base 1 is configured as the anti-vibration support mechanism 2.

When an active anti-vibration apparatus is adopted as the anti-vibration support mechanism 2, the actuators 21 used to control the vibration of the lens barrel base 1 on the basis of a signal output from the vibration detection sensor 22 can be used as the anti-vibration support mechanism 2 or its component.

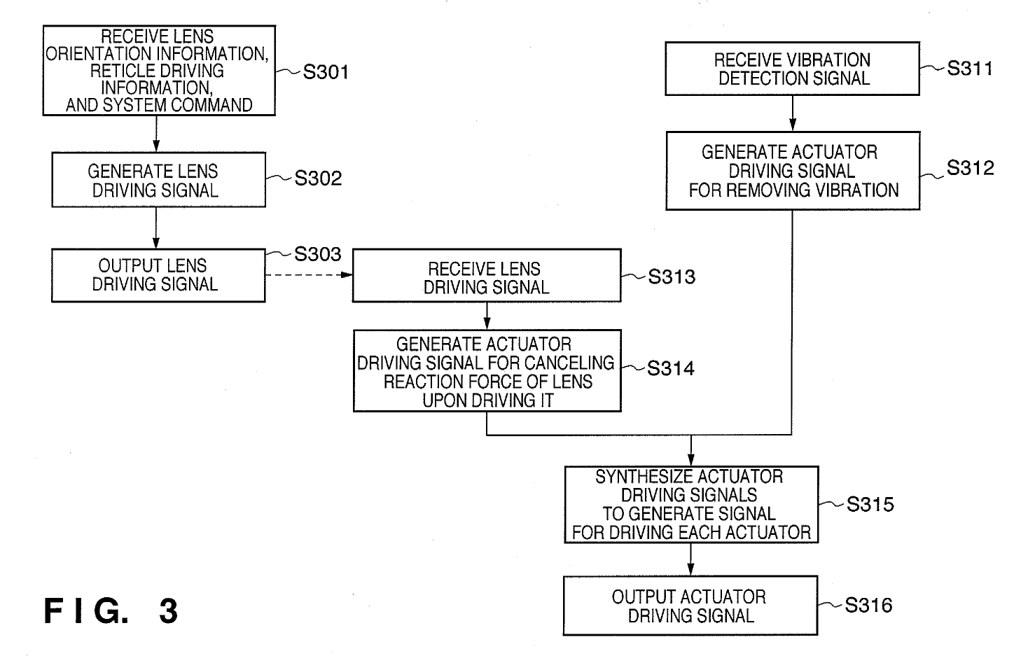

FIG. 2 is a block diagram showing details of the configuration of the control unit 7. The control unit 7 has the lens controller 71 and vibration controller 72. FIG. 3 is a flowchart for explaining the operation of the control unit 7.

The lens controller 71 receives a signal indicating the attitude of the projection lens 11a from the lens sensor 11c, reticle driving information 34 indicating the operation state of the reticle stage unit 32, and a system command 15 from a host system (S301). On the basis of these received signals and information, the lens controller 71 generates a lens driving signal for controlling the movable lens unit 11 to correct the aberration or magnification change of the image plane (S302). The lens driving signal generated by the lens controller 71 is sent to the lens driving circuit 9 and vibration controller 72 (S303).

The vibration controller 72 receives the detection signal from the vibration detection sensor 22 (S311). On the basis of this detection signal, the vibration controller 72 executes arithmetic compensation operation to generate an actuator driving signal for driving the actuator 21 to control the vibration of the lens barrel base 1 in an appropriate state (S312). The vibration controller 72 also receives the lens driving signal output from the lens controller 71 (S313). The vibration controller 72 executes arithmetic compensation operation for the lens driving signal to generate an actuator driving signal for controlling each actuator 21 to produce a controlled force which substantially cancels the reaction force of the movable lens unit 11 (projection lens 11a) produced upon driving it (S314). The vibration controller 72 synthesizes the actuator driving signals generated in steps S312 and S314 to generate an actuator driving signal for driving each actuator 21 (S315). The vibration controller 72 outputs the actuator driving signal obtained in step S315 to a corresponding actuator driving circuit 8 (S316). The actuator driving circuit 8 drives a corresponding actuator 21 on the basis of the actuator driving signal supplied from the vibration controller 72 to reduce vibration generated by the lens barrel base 1.

An anti-vibration action by the above-described semiconductor exposure apparatus will be explained in detail below.

When the lens driving unit 11b of the movable lens unit 11 is driven on the basis of a lens driving signal from the lens controller 71, the attitude of the projection lens 11a changes in accordance with the lens driving signal. The reaction of the projection lens 11a upon driving it to change its attitude is transmitted to the projection optical system 10 and the lens barrel base 1 which mounts it, so that they generate vibration.

Normally, the driving force of the projection lens 11a is relatively small. However, the anti-vibration level required in this industrial field is very high, so the vibration of the projection lens 11a upon driving it may have influences on other units mounted on the lens barrel base 1, especially, the projection optical system 10 and various measurement systems of the exposure apparatus. The apparatus according to this embodiment substantially cancels the driving reaction force of the movable lens unit 11 by the actuators 21 which apply controlled forces to the lens barrel base 1, thereby reducing the vibration of the lens barrel base 1.

More specifically, as described above, lens driving information generated by the lens controller 71 to drive the movable lens unit 11 is sent to the vibration controller 72. The sent information here includes at least one of a lens driving signal and pieces of information associated with the lens driving start/stop timing and various driving methods. On the basis of these pieces of information received from the lens controller 71, the vibration controller 72 generates a driving signal for driving the actuator 21 so that the lens barrel base 1 will not generate vibration upon lens driving.

When, for example, the vibration controller 72 receives a lens driving signal from the lens controller 71, it calculates a controlled force produced by the lens driving unit 11b from the received driving force. This controlled force calculation takes account of the dynamics from a driving signal for the lens driving unit 11b to a controlled force. If a controlled force produced by the lens driving unit 11b is substantially proportional to a lens driving signal free from any delay within a frequency region of interest, an actuator driving signal need be generated by referring to the driving signal and driving gain. In contrast, if the controlled force has a significant delay with respect to the driving signal, an arithmetic phase-lead compensation operation or the like need be executed to correct the delay. The vibration controller 72 executes appropriate gain processing/filter processing for the thus calculated controlled force of the lens driving unit 11b to generate a driving signal for the actuator 21 to substantially cancel the controlled force.

When the actuator 21 is an electromagnetic actuator excellent in response characteristic, a driving signal for the actuator 21 can be regarded as a controlled force with little delay. Hence, a signal obtained by multiplying the calculated controlled force of the lens driving unit 11b by an appropriate gain may be used as an actuator driving signal.

Although a case in which vibration due to a lens driving reaction force is prevented using a lens driving signal has been exemplified above, it is also possible to use a signal other than a lens driving signal. For example, there is a method of monitoring how the lens barrel base 1 swings as a result of lens driving, and preparing processing corresponding to a signal from the lens controller 71 in advance so as to generate a vibration canceling driving signal on the basis of the monitored state. More specifically, there is a method of associating a lens driving signal with an actuator driving signal in advance on the basis of actual measurement, and holding them in, e.g., a table.

The vibration controller 72 also receives a signal indicating the vibration of the lens barrel base 1 from the vibration detection sensor 22, and generates an actuator driving signal for reducing the detected vibration on the basis of the received signal.

Therefore, the vibration controller 72 obtains

(1): a compensation signal (an actuator driving signal for reducing vibration due to lens driving, which is obtained in step S314) based on lens driving, and

(2): a compensation signal (an actuator driving signal for reducing detected vibration, which is obtained in step S312) based on a signal from the vibration detection sensor 22.

The vibration controller 72 synthesizes these compensation signals to generate an actuator driving signal (S315), and sends it to the actuator driving circuit 8. The actuator driving circuit 8 drives a corresponding actuator 21 on the basis of the actuator driving signal from the control unit 7 (vibration controller 72). As the actuator 21 is driven, the action forces of the lens driving unit 11b to the projection optical system 10 and lens barrel base 1 are canceled. This dramatically reduces the vibration of the projection optical system 10 and lens barrel base 1 as compared with a case in which the control configuration according to this embodiment is not used.

As described above, according to the first embodiment, it is possible to quickly reduce the vibration of the lens barrel base 1 and projection optical system 10 generated by the driving reaction force of the projection lens upon driving it to correct the aberration or magnification change of the image plane.

### Second Embodiment

When a control unit 7 obtains lens driving information for the respective translational/rotational rigid-body motion modes of a projection lens 11a from a lens controller 71, vibration control can be done with a higher accuracy and predictability. That is, a lens or lens barrel base can be controlled and adjusted for their respective rigid-body motion behaviors (X, Y, Z, θx, θy, and θz) so as to perform adjustment matching the object behavior. In the second embodiment, a control unit 7 of this kind will be explained.

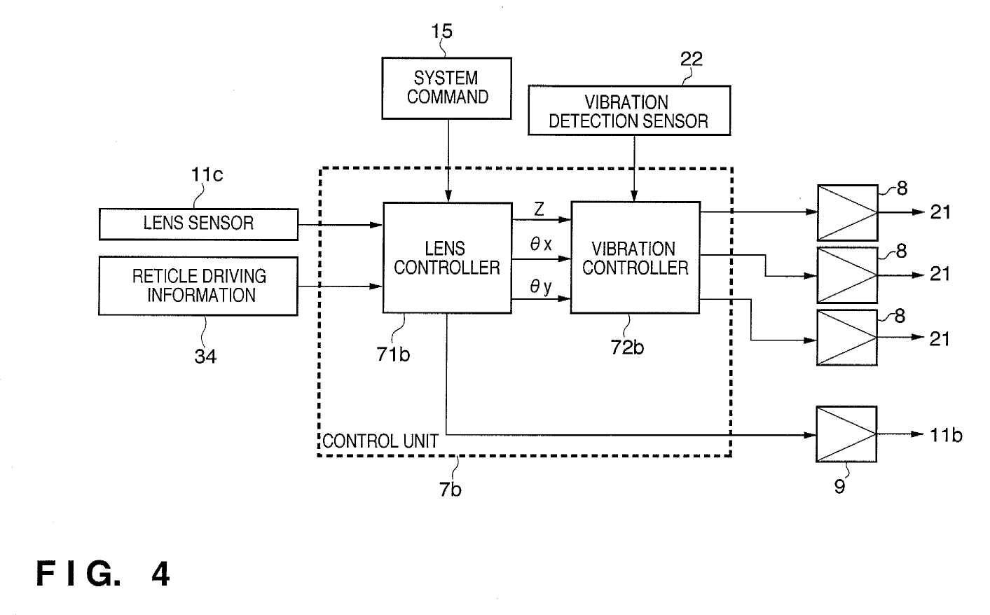

FIG. 4 is a block diagram showing a configuration of a control unit according to the second embodiment. To distinguish the configuration shown in FIG. 4 from that shown in FIG. 2 according to the first embodiment, a control unit, lens controller, and vibration controller are denoted by reference numerals 7b, 71b, and 72b, respectively.

The second embodiment is the same as the first embodiment (FIG. 2) in a sequence until the lens controller 71b in the control unit 7b generates a lens driving signal, but is different in a lens driving signal supplied to the vibration controller 72b. That is, the lens controller 71b according to the second embodiment divides a lens driving signal into signals for the respective translational/rotational rigid-body motion modes, and sends them to the vibration controller 72b. FIG. 4 exemplifies such driving signals as driving signals of translation Z and rotation through θx and θy about the horizontal X- and Y-axes orthogonal to each other.

The vibration controller 72b executes arithmetic compensation operation for the received signals for the respective motion modes, The vibration controller 72b distributes (executes thrust distribution operation for) the driving signals to control actuators 21 to generate controlled forces for a lens barrel base 1, which suppress the reaction force of the projection lens 11a upon driving it. At this time, the vibration controller 72b distributes the control operation result for each motion mode so that a plurality of actuators 21 apply controlled forces to the lens barrel base 1 in its Z, θx, and θy motion directions. The above-described thrust distribution operation can be formulated on the basis of, e.g., the geometrical arrangement information of the actuators 21 on the lens barrel base 1.

FIG. 4 specifies three actuator driving circuits because at least three or more actuators need be driven to control the degrees of freedom of motion of the lens barrel base 1 in its Z, θx, and θy directions.

The arrangement according to the second embodiment as described above can easily detect the relationship between the attitudes of the projection lens 11a and lens barrel base 1 so as to perform their control and adjustment with a good predictability. This makes it possible to obtain a more satisfactory vibration control effect.

As described above, according to the first and second embodiments, it is possible to quickly reduce the vibration of the base and projection lens generated by the driving reaction force of the projection lens upon driving it to correct the aberration or magnification change of the image plane. Especially in recent years, along with an improvement in the performance of a scanning exposure apparatus which synchronously scans a reticle and wafer, an apparatus which performs exposure with lens driving in accordance with the scanning of a stage unit is arriving on the market. In this apparatus, as the scanning speed improves, the lens driving reaction force increases. According to the above-described embodiments, it is possible to achieve a vibration environment more silent than in the prior arts even while meeting a stricter apparatus operation condition. This makes it possible to attain a more satisfactory vibration control performance and even a more satisfactory exposure performance of a semiconductor exposure apparatus. That is, even when a movable lens unit 11 is controlled to drive the projection lens in accordance with the synchronous scanning of a reticle stage unit 32 and wafer stage unit 42, it is possible to satisfactorily reduce vibration due to its driving reaction force.

Although the first and second embodiments have exemplified a case in which a projection optical system 10 is mounted on the lens barrel base 1, the present invention is not particularly limited to this. For example, it is obviously possible to control the projection optical system 10 even when the first and second embodiments are applied to a case in which an anti-vibration support mechanism 2 and actuator 21 directly act on the projection optical system 10 without any specially provided lens barrel base 1. That is, the actuator 21 need only directly or indirectly apply a controlled force to the projection optical system 10.

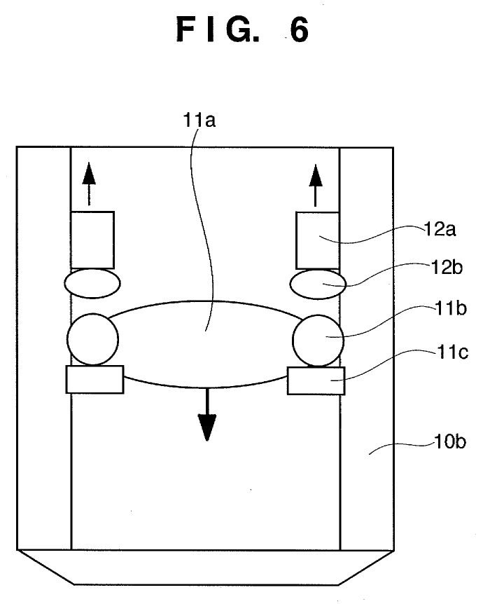

The actuator 21 may drive a mass mounted on the projection optical system 10 to reduce vibration due to the driving reaction force of the projection lens. Assume that the mass is an inertial load which acts in a direction of degree of freedom, which is the same as the driving direction of the projection lens and which is opposite to it. When the mass is driven by a lens driving signal for driving the projection lens, it is possible to reduce vibration due to the driving reaction force of the projection lens. Hence, a vibration controller 72 can omit the calculation of a driving signal corresponding to the driving of the projection lens of the actuator 21. Details of this mechanism will be described later in the third embodiment (FIG. 6).

### Third Embodiment

The third embodiment will be explained next.

In the third embodiment, an arrangement is provided which absorbs the reaction force of a projection lens 11a produced upon driving it by a movable lens unit 11.

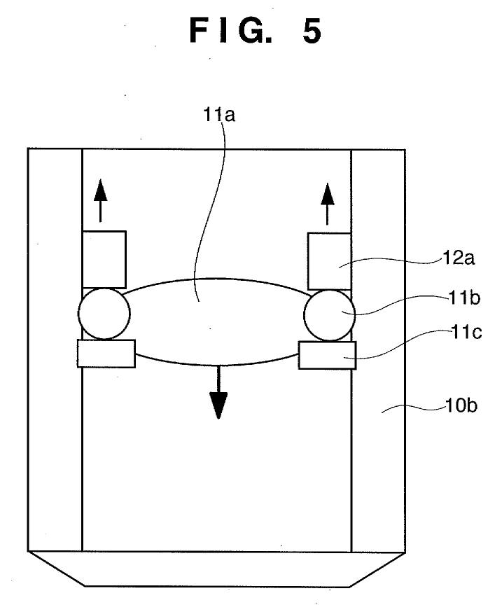

FIG. 5 is a view showing an arrangement of a projection optical system according to the third embodiment. In FIG. 5, the projection optical system according to the third embodiment is denoted by reference numeral 10b to distinguish it from the projection optical system 10 according to the first embodiment. As in the first embodiment, a lens barrel base 1 supported with vibration control by an anti-vibration support mechanism 2 supports the projection optical system 10b.

As in the first embodiment, the projection optical system 10b comprises the movable lens unit 11 having the projection lens 11a, a lens driving unit 11b, and a lens sensor 11c. The functions and operations of the units of the movable lens unit 11 are the same as those in the first embodiment.

The projection optical system 10b of a semiconductor exposure apparatus according to the third embodiment also mounts an inertial load 12a which moves in a direction of degree of freedom, which is the same as the direction, in which the lens driving unit 11b drives the projection lens 11a, and which is opposite to it.

In the third embodiment, the lens driving unit 11b is configured to transmit the reaction force of the projection lens 11a, which is produced as the lens driving unit 11b applies a controlled force to it, not to the projection optical system 10b and lens barrel base 1 but to the inertial load 12a. An actuator is arranged such that the lens driving unit 11b produces a force which acts between the projection lens 11a and the inertial load 12a. That is, the lens driving unit 11b drives the projection lens 11a and also drives the inertial load 12a in a direction opposite to the driving direction of the projection lens 11a at the same time. The actuator used here is preferably an actuator such as an electromagnetic linear motor, which produces a force in proportion to its driving signal.

As has been described in the first embodiment, a lens controller 71 controls the lens driving unit 11b in accordance with an arithmetic compensation operation result based on, e.g., information about the position/attitude of the projection lens 11a detected by the lens sensor 11c. Since the lens driving unit 11b is arranged such that it produces a force which acts between the projection lens 11a and the inertial load 12a, its driving reaction force is transmitted not to the projection optical system 10b and lens barrel base 1 but to the inertial load 12a. This makes it possible to greatly reduce the amounts of transmission of lens driving reaction forces to the projection optical system 10b and lens barrel base 1, thus suppressing their vibration to a minimum. In this case, a vibration controller 72 can omit the generation of driving signals for reducing the driving reaction force of the movable lens unit 11 (S313 to S315).

The inertial load 12a may be driven by an inertial load driving unit 12b on the basis of a signal from the lens controller 71, as shown in FIG. 6, instead of the reaction force of the lens driving unit 11b. In this case, it is desirable to arrange the inertial load driving unit 12b close to the lens driving unit 11b as much as possible so that they are controlled to produce substantially equivalent controlled forces. The arrangement shown in FIG. 6 is effective when the inertial load 12a cannot be integrated with the lens driving unit 11b from the viewpoint of unit layout design limit. Also in this case, the vibration controller 72 can omit the generation of driving signals for reducing the driving reaction force of the movable lens unit 11 (S313 to S315) because the inertial load 12a is driven in accordance with a lens driving signal.

The movable lens unit 11, inertial load 12a, and inertial load driving unit 12b have been explained using only one control axis. However, actual lens driving is often done by arranging a plurality of combinations of them. A case in which the above-described arrangement is adopted in this form falls within the spirit and scope of the present invention.

The present invention can be used as a lens driving mechanism and anti-vibration apparatus of a semiconductor exposure apparatus, and a control method therefor.

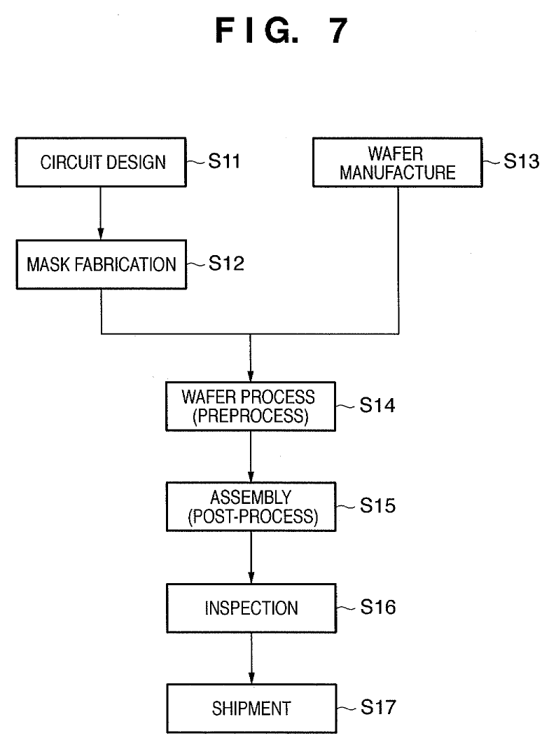

A process of manufacturing a semiconductor device using the above-described exposure apparatus will be explained next. FIG. 7 illustrates the overall sequence of a process of manufacturing a semiconductor device. In step S11 (circuit design), the circuit of a semiconductor device is designed. In step S12 (mask fabrication), a mask on which the designed circuit pattern is formed is fabricated. In step S13 (wafer manufacture), a wafer substrate is manufactured using a material such as silicon.

In step S14 (wafer process) called a preprocess, an actual circuit is formed on the wafer by lithography using the prepared mask and wafer. In step S15 (assembly) called a post-process, a semiconductor chip is formed using the wafer manufactured in step S14. This step includes an assembly step (dicing and bonding) and packaging step (chip encapsulation). In step S16 (inspection), the semiconductor device manufactured in step S15 undergoes inspections such as an operation confirmation test and durability test. After these steps, the semiconductor device is completed and shipped in step S17.

The preprocess and post-process are individually performed in dedicated factories and maintained by the above-described remote maintenance system for the respective factories. The preprocess and post-process factories perform data communication by exchanging production management and apparatus maintenance information via the Internet or a dedicated network.

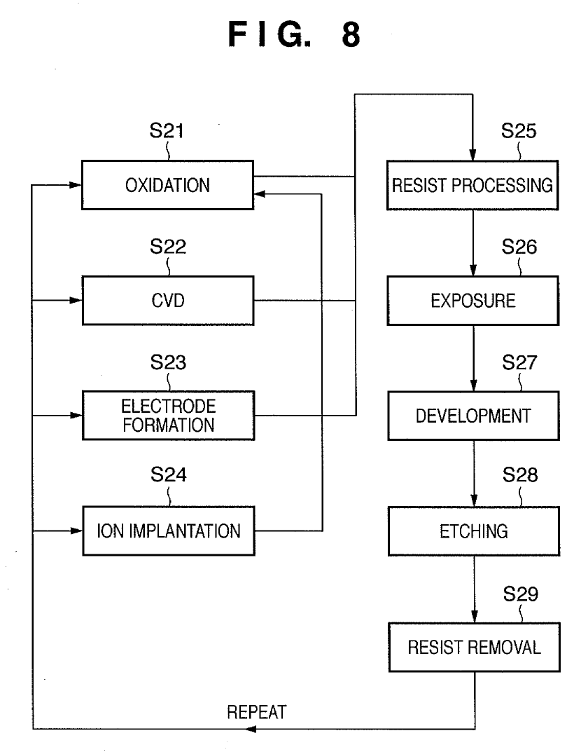

FIG. 8 illustrates the detailed sequence of the wafer process. In step S21 (oxidation), the wafer surface is oxidized. In step S22 (CVD), an insulating film is formed on the wafer surface. In step S23 (electrode formation), an electrode is formed on the wafer by vapor deposition. In step S24 (ion implantation), ions are implanted into the wafer. In step S25 (resist processing), a photosensitive agent is applied on the wafer. In step S26 (exposure), the above-described X-ray exposure apparatus prints the circuit pattern of the mask on the wafer by exposure. In step S27 (development), the exposed wafer is developed. In step S28 (etching), portions other than the developed resist image are etched. In step S29 (resist removal), any unnecessary resist remaining after etching is removed.

By repeating these steps, a multilayered structure of circuit patterns is formed on the wafer.

According to the present invention, it is possible to reduce the vibration of an exposure apparatus generated by the driving reaction force of a projection lens in a projection optical system. This makes it possible to attain high-speed, high-accuracy exposure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-060903, filed Mar. 9, 2007, which is hereby incorporated by reference herein in its entirety.

What is claimed is:

1. An exposure apparatus for exposing a substrate to light, the apparatus comprising:
a projection optical system including an optical element and a driving unit configured to move the optical element, the projection optical system configured to project light from an original to the substrate;
a support mechanism including a gas spring and configured to support the projection optical system via the gas spring;
a control unit configured to generate a driving signal for the driving unit; and
an actuator configured to apply a force, in accordance with the driving signal, to the projection optical system in a direction opposite to a direction of a reaction force accompanied by an action force from the driving unit to the optical element.

2. An apparatus according to claim 1, further comprising:
a support member configured to support the projection optical system and be supported by the support mechanism,
wherein the actuator is configured to apply a force to the support member to apply a force to the projection optical system via the support member.

3. The apparatus according to claim 1, further comprising:
an object configured to be movable relative to the projection optical system,
wherein the actuator is included in the projection optical system and configured to move, in accordance with the driving signal, the object in a direction opposite to a moving direction of the optical element.

4. An exposure apparatus for exposing a substrate to light, the apparatus comprising:
a projection optical system including an optical element and a driving unit configured to move the optical element, the projection optical system configured to project light from an original to the substrate;
a support mechanism including a gas spring and configured to support the projection optical system via the gas spring; and
an object included in the projection optical system and configured to be movable relative to the projection optical system,
wherein the driving unit is configured to produce a force which acts from the object to the optical element.

5. A method of manufacturing a device, the method comprising:
exposing a substrate to radiant energy using an exposure apparatus according to claim 1;
developing the exposed substrate; and
processing the developed substrate to manufacture the device.

6. A method of manufacturing a device, the method comprising:
exposing a substrate to radiant energy using an exposure apparatus according to claim 4;
developing the exposed substrate; and
processing the developed substrate to manufacture the device.
